(19) United States
(12) Patent Application Publication
(10) Pub. No.: US 2024/0095688 A1
(43) Pub. Date: Mar. 21, 2024

(54) DETECTION OF IDENTIFIERS ON RETURNABLE GOODS AND FOR RETURN DEVICE IN ORDER TO REDEEM A DEPOSIT CREDIT

(71) Applicant: DIGI-CYCLE GMBH, Wien (AT)

(72) Inventors: Andreas OPELT, Graz (AT); Georg KETZLER, Wien (AT)

(21) Appl. No.: 18/038,684

(22) PCT Filed: Nov. 23, 2021
(86) PCT No.: PCT/EP2021/082617

§ 371 Date: May 24, 2023

(30) Foreign Application Priority Data
Nov. 24, 2020 (AT) A51022/2020
Feb. 24, 2021 (AT) A50126/2021

(51) Int. Cl. G06Q 10/30; G06Q 20/32

(52) U.S. Cl. CPC G06Q 10/30; G06Q 20/3224; G06Q 20/3276

(57) ABSTRACT

Method for managing a pledged property, wherein the method comprises, prior or during a transfer of an entitlement to the pledged property to a user, activating the pledged property, wherein the pledged property is provided with a first identifier, when transferring the pledged property to a return unit, recognizing the first identifier and recognizing a second identifier which is assigned to the return unit, and triggering a deposit credit when the first identifier which is recognized at the return unit indicates a previously activated pledged property.

This application is a national US phase of PCT/EP2021/082617 which claims the benefit of the filing date of Austrian Patent Application No. A51022/2020 filed 24 Nov. 2020 as well as of Austrian Patent Application No. A50126/2021 filed 24 Feb. 2021, the disclosure of which is hereby incorporated herein by reference.

### TECHNICAL FIELD

Embodiments of the invention relate to a method for managing a pledged property, an arrangement, and a computer-readable storage medium, and a program element.

Technological Background

A deposit system denotes in particular a system of returning consumer goods (the pledged property (German: Pfandgut)) to the vendor or a special connection point for the purpose of recycling, either of the good itself, or its material substance, wherein the motivation for the consumer for returning the good is created by the consumer giving a value (the deposit or the stake) when receiving the good, which value he receives back or is credited with the return of the good.

It is still difficult to perform the management of pledged properties in an efficient, misuse-proof manner with a high user comfort and with a reasonable effort.

### SUMMARY OF THE INVENTION

There may be a need to perform the management of pledged properties in an efficient, fraud-proof, user convenient manner and with a reasonable effort.

This need is met by a method for managing a pledged property, an arrangement, and a computer-readable storage medium, and a program element with the features according to the independent patent claims.

According to an embodiment of the present invention, a method for managing a pledged property is provided, wherein the method comprises, prior or during a transition of an entitlement to the pledged property to a user, activating (or registering) the pledged property, wherein the pledged property is provided with a first identifier, when transferring the pledged property to a return unit, recognizing the first identifier and recognizing a second identifier which is assigned to the return unit, and triggering a deposit credit (German: Pfandgutschrift), when the first identifier which is recognized at the return unit indicates a previously activated pledged property (wherein triggering the deposit credit may in particular be performed under the further condition that for the pledged property no deposit credit was triggered yet).

According to another embodiment of the present invention, a method for managing a pledged property is provided, wherein the method comprises, during transferring an entitlement to the pledged property to a user, recognizing a first, preferably unique, identifier the pledged property is provided with, and activating (or registering) the pledged property. When transferring the pledged property to a return unit, repeatedly recognizing the first identifier and recognizing a second identifier the return unit is provided with, are performed. Furthermore, the method comprises triggering a deposit credit when the repeatedly recognized first identifier indicates a previously activated pledged property (wherein triggering the deposit credit may in particular only be performed under the further condition that for the pledged property no deposit credit was triggered yet).

According to another embodiment of the present invention, an arrangement for managing a pledged property is provided, wherein the arrangement comprises an output unit for outputting the pledged property, the pledged property which is provided with a first identifier, a return unit to which a second identifier is assigned, a user terminal device, and a control unit, wherein the control unit is configured, prior or during a transition of an entitlement to the pledged property from the output unit to a user, to activate the pledged property, wherein the user terminal device is configured, when transferring the pledged property to the return unit, to recognize the first identifier, and the user terminal device and/or the control unit is or are configured, when transferring the pledged property to the return unit, to recognize the second identifier, and wherein the control unit is configured, triggered by recognizing the first identifier and by recognizing the second identifier, to trigger a deposit credit, when the recognized first identifier indicates a previously activated pledged property.

According to yet another embodiment of the present invention, an arrangement for managing a pledged property is provided, wherein the arrangement is preferably configured for generating and outputting unique identifiers. The arrangement comprises an output unit for outputting the pledged property, the pledged property which is provided with a first identifier, a return unit which is provided with a second identifier, a user terminal device, and a control unit, wherein the output unit or the user terminal device is configured, when transferring an entitlement to the pledged property to a user, to recognize the first identifier, wherein the control unit is configured, triggered by recognizing the first identifier, to activate the pledged property, wherein the user terminal device is configured, when transferring the pledged property to the return unit, to repeatedly recognize the first identifier and the second identifier, and wherein the control unit is configured, triggered by repeatedly recognizing the first identifier and by recognizing the second identifier, to trigger a deposit credit, when the repeatedly recognized first identifier indicates a previously activated pledged property (wherein triggering the deposit credit in particular is performed only under the further condition that for the pledged property no deposit credit was triggered yet).

In a computer-readable storage medium according to an embodiment of the present invention, a program for managing a pledged property is stored, which program, when it is executed by one or more processors (of the user terminal device and/or of at least one control unit which is communicatively couplable to it), controls and/or performs the above-described method steps or a part of them.

A program element (computer program element) according to an embodiment of the present invention for managing a pledged property comprises the above-described method stages (respectively performs them), when it is executed by one or more processors (for example of the user terminal device and/or of at least one control unit which is communicatively couplable with it and/or of an output unit). For example, the program element may be configured as an app which may be downloaded by the user terminal device via a communication network from a server and may then be executed on it. The program element may comprise single partial elements which may be executed at different processors. Also the control unit and/or the output unit may be equipped with a corresponding software.

Embodiments of the present invention may be realized both by a computer program, i.e. a software, and by one or more special electric circuits, i.e. in hardware, or in an arbitrarily hybrid form, i.e. by software components and hardware components. In particular, in an embodiment of the invention, the software may also be at least partially configured as an app, i.e. as a downloadable and then installable software-application, in particular for the user terminal device.

In the context of the present invention, the term “pledged property” (deposit property, German: Pfandgut) may in particular denote a body or a plurality of bodies which is or are temporarily used for a predetermined use and which shall be disposed after use. To motivate a user to perform the disposal, the issuance of the pledged good may be coupled to the payment of a deposit fee, which is fully or partially repaid to the user, and in an identical manner, or in form of a surrogate (for example in the form of the issuance of a new pledged property or a voucher and/or a credit note) when returning or disposing the pledged property. For example, the pledged property may be or comprise a deposit bottle (in particular a deposit PET bottle), a deposit can, a container (in particular a beverage crate), a battery, a textile, a piece of furniture, a deposit packaging, a motor vehicle, a cuboid packaging for liquid foodstuffs or for low-viscosity foodstuffs (for example a Tetrapack), a can, a packaging container (German: Verpackungsgebinde), a Euro palette, and an electronic device (in particular a waste electronic device).

In the context of the present invention, the term “output unit” may in particular denote an entity at which a user may receive (for example buy) a pledged property or multiple pledged properties. This may be a retail store, for example.

In the context of the present invention, the term “return unit” may in particular denote an entity, at which or by which a return of the pledged property after its use is enabled. The return of the pledged property may be performed for a disposal of the pledged property or to bring the pledged property back on the market (for example after cleaning and refilling), for example. For example, the return unit may be a garbage bag, a return container, or a return station (which may be arranged at the location of the output unit, for example in a retail store). For example, the return unit may also be a waste collection center.

In the context of the present invention, the term “user terminal device” may in particular denote an electronic device which may be operated by a user. Preferably, such a user terminal device is communicatively operable in a communication network. Furthermore, it is preferred that a user terminal device comprises a resource for recognizing an identifier, in particular a scanner. Further in particular, the user terminal device may be a portable device which may be carried by a user. Preferably, the user terminal device is a mobile device, a laptop, or a tablet-PC. A user may conveniently carry such a user terminal device and may use it at the location of a return unit for triggering a deposit credit, for example. For example, on the user terminal device, a software, in particular an app, may be installed, by which an operation of the user terminal device in the context of embodiments of the invention is enabled.

In the context of the present invention, the term “control unit” may in particular denote an entity which comprises processor resources and storage resources. The processor may be configured for executing a software which is stored in a storage and may access the storage resources (for example for activating a pledged property and/or for performing a deposit credit). For example, the control unit may be a computer, in particular a server computer. For example, the control unit may function as a master in a communication network with a user terminal device, an output unit and/or a return unit, whereas the user terminal device, the output unit and/or the return unit may function as slave(s). The control unit may also be configured to communicate with and/or to control a multiplicity of user terminal devices.

In the context of the present invention, the term “identifier” may in particular denote a physical structure which may be physically connected or connectable to the pledged property and/or with a return unit, and which may serve for a (preferably unique) identification of a certain pledged property or a certain group of pledged properties and/or of the return unit. For example, such an identifier may be a two-dimensional QR-code, a one-dimensional barcode, or stripe code, a transponder (for example an RFID (radio frequency identification)-tag, or NFC (near field identification)-tag) and/or an alphanumeric code (i.e. a sequence of letters and/or ciphers and/or other characters). Other identifiers which may be, in particular electrically and/or electromagnetically (for example optically), recognizable or readable, may also be implemented according to exemplary embodiments of the invention. In the context of the present invention, the term “identifier” may in particular also denote a virtual structure (for example a data set) which may be logically and/or data-technically assigned to the return unit, and may serve for the (preferably unique) identification of the return unit. For example, such an identifier may be a data set (for example stored in the control unit and/or in the user terminal device) which indicates a spatial position of a return unit and a spatial region around it, wherein the recognition of such an identifier by recognizing may encompass the intrusion of a user terminal device in this spatial region (in particular based on position data of the user terminal device).

In the context of the present invention, the term “activating a pledged property” may in particular denote an action by which a certain pledged property is marked (for example in a database) in a manner which reflects the circumstance, that the pledged property is transitioned in the authorization area of the user and therefore the authorization, to receive a deposit credit at the return unit in case of a return or disposal of the pledged property, is transferred to the user. Activating the pledged property may be triggered by a communication message to a control unit, by which it is expressed that the pledged property is transitioned in the authorization area of the user. The control unit may then record the activation by a corresponding marking of the pledged property (for example in a user-assigned manner) in a database. In this way, a misuse may be avoided. However, activating a pledged property may also be performed prior or while manufacturing the pledged property (in particular being filled with a product, such as a beverage), by performing a corresponding database entry. Such a database entry of an activated pledged property may contain an information about the first identifier. Thus, a first identifier and a pledged property may be firmly assigned to each other, so that an activation of the first identifier also activates the assigned pledged property and vice versa.

In the context of the present invention, the term “triggering a deposit credit” may in particular denote that the deposition credit is initiated in favor of the user. For example, this may be performed by an electronic credit on an account of the user, i.e. by a corresponding communication message. A trigger for the deposit credit may be that repeatedly recognizing the first identifier and recognizing the second identifier for the first time (in particular temporarily and/or spatially sufficiently close to each other) are performed, and for the pledged property, no deposit credit (in particular for this user) has been performed yet. Thereby, the operational safety may be increased since multiple deposit credits for the same pledged property or triggering a deposit credit without returning or disposal of the pledged property may be avoided.

According to an embodiment of the invention, for example a filled PET beverage bottle or another pledged property may be bought at an output unit, such as a retail store, by a user under payment of a deposit. By recognizing or detecting a first identifier at the pledged property, for example by recognizing or detecting a QR-code at the pledged property, the pledged property may be identified and a first communication message which contains an identification information with respect to the identified pledged property may be transferred from the output unit or from a user terminal device to a central control unit. This first communication message may indicate that a certain pledged property is transferred to the user. When receiving the first communication message, the pledged property may be activated by the control unit. For example, this may be performed by placing a flag in a database or by another electronic marking of the pledged property which is identified and transferred to the user. For example, the control unit and the database may manage and/or contain data sets with respect to a multiplicity of pledged properties, for example for at least thousand pledged properties, at least one million pledged properties, or even at least one billion pledged properties. Each pledged property may be distinguishable from all other pledged properties by a separate first identifier. When the user later disposes a previously activated pledged property, for example a PET beverage bottle which has been emptied in the meantime, at a return unit, the user may recognize or detect the first identifier at the pledged property for a second time, for example by (in particular repeatedly) scanning the first identifier by a user terminal device (for example a mobile phone). When—preferably within a pregiven time interval (of maximum 10 minutes, for example)—the user, by the user terminal device, also detects or recognizes (for example scans) a second identifier of the return unit (for example a garbage bag with a QR-code), by transferring both recognized or detected identifiers of the pledged property and the return unit, by way of a second communication message from the user terminal device to the central control unit, a disposal proof with respect to the pledged property may be provided. For example, the control unit may then perform a database comparison. In this context, by searching the database, it may be detected if the pledged property for which a return proof or disposal proof was provided by the double scan of both identifiers, was previously activated (in particular triggered by the first communication message which was sent from the return unit or the user terminal device to the control unit). If the database query results that the disposed pledged property was previously activated, a deposit credit may be triggered in favor of the user (for example, a deposit which was paid at the output unit by the user can be credited to an account of the user or the deposit may be issued to the user in cash). In this way, with a very low effort, at the same time error-robust and misuse-secure and with a high user convenience, a deposit system may be implemented which is scalable for an arbitrary number of pledged properties and which may be intuitively performed by a user without special knowledge. Also the software-technical and hardware-technical retrofitting-effort, starting from available resources, is very low. Thus, an embodiment of the invention is directed to a system for issuing and controlling unique computer-readable identifiers at the pledged property.

In an alternative—and even preferred—embodiment, a pledged property—in particular by a control unit—may be activated prior or while manufacturing the pledged property by a manufacturing unit, i.e. even prior to the transfer of the pledged property to a user. For example, the activation may be performed by placing a flag in a database or by another electronic marking of the pledged property which is manufactured or yet to be manufactured. In particular, the activation may be performed during a generation of the first identifier or an identification code which is indicative for it. Each pledged property may be distinguishable from all other pledged properties by a separate first identifier. When activating the pledged property which is manufactured or yet to be manufactured, the assigned first identifier for identifying this pledged property may be included in a database with activated first identifiers (and thus for activating assigned pledged properties). Descriptively, all pledged properties which are provided or are later provided with an activated first identifier may also be activated by activating the assigned first identifier. In particular, this embodiment has the advantage that outputting the pledged property at an output unit to a user does not require identifying and activating the pledged property, since the activation has already previously been performed. A special adaption or retrofitting of the output unit for performing the method is thus dispensable. This simplifies the performance of the method and the structure of the arrangement. A fraud-secure and reliably controllable return of the pledged property may be performed by recognizing the first identifier of the pledged property at a return unit and by recognizing a second identifier which is assigned to the return unit. Recognizing the first identifier and the second identifier may be treated as a disposal proof and may trigger the deposit credit for the pledged property which is assigned to the recognized first identifier.

In the following, preferred further developments of the method, the arrangement, the computer-readable storage medium, and the program element are described.

According to an embodiment, the method may comprise activating the pledged property prior or during providing an identification code or the first identifier to a manufacturing unit for manufacturing the pledged property and for providing the pledged property with the first identifier, wherein the first identifier is indicative for the identification code (in other words, an identification information which is data-technically defined by the identification code (for example a data element), may be physically depicted by the first identifier (for example a QR-code-label); in particular, the identification code may place a link on a database in which activated first identifiers and/or assigned identification codes may be included). In a corresponding manner, the arrangement may comprise a manufacturing unit which is configured for manufacturing the pledged property and for providing the pledged property with the first identifier, wherein the control unit is configured for activating the pledged property prior or during manufacturing. Furthermore, the control unit may be configured for providing an identification code or the first identifier to the manufacturing unit, wherein the first identifier may be indicative for the identification code. Moreover, the control unit may be configured for activating the pledged property prior or during providing the identification code or the first identifier to the manufacturing unit. For example, the control unit may merely transmit an identification code (for example a data set with an information for manufacturing a first identifier as a physical body, for example as a label) to the manufacturing unit, on which basis the manufacturing unit may physically manufacture the first identifier. Preferably prior or during manufacturing the pledged property with the first identifier which is attached to it, the actuation may be performed on the side of the system and/or on the side of the control unit. Descriptively, the identification code or the first identifier may be generated on the side of the system or by the control unit. For example, the activation may be performed prior or when obtaining the identification code or the first identifier by the manufacturing unit, i.e. prior or during the transition of the identification code or the first identifier to the manufacturing unit. An activation under participation of the user and/or the output unit may then be dispensable with advantage. A retrofitting of an existing output unit is also not necessary in this case, to be able to operate the output unit with a method according to an exemplary embodiment. This significantly reduces the effort.

For example, the identification code (for example a data set with an information by which the first identifier, for example a QR-code-label, may be manufactured) or the first identifier itself (for example a QR-code-label) may be centrally generated by the system (in particular by the control unit) and may be provided to the manufacturing unit. The identification code or the first identifier and thus also a pledged property which is to be provided with it may therefore be already activated at the time of the generation. The time of the activation may also be the time at which the identification code or the first identifier is transferred to the manufacturing unit, for example when at this time a corresponding database entry is performed. For example, in case of a deposit bottle, the manufacturing unit may give identification codes to a label manufacturer which prints the entire labels with corresponding first identifiers and returns them to the manufacturing unit. The manufacturing unit attaches the entire labels with the respective first identifier to the deposit bottles. In case of deposit cans, this providing the pledged property with a first identifier may be performed by lasering the first identifier to the deposit can, for example by the manufacturing unit.

According to another embodiment, the method may comprise, when transferring the entitlement to the pledged property to the user, activating the pledged property. In a corresponding manner, at the arrangement, the control unit may be configured, triggered by recognizing the first identifier for the first time at the output unit, to activate the pledged property. For example, the activation may be performed by scanning the first identifier of a pledged property.

According to an embodiment, wherein the activation of a pledged property is performed prior or during manufacturing, the method may comprise, when transferring the pledged property to the return unit, recognizing the first identifier for the first time. In a corresponding manner, at the arrangement, the control unit may be configured, triggered by recognizing the first identifier for the first time at the return unit and by recognizing the second identifier at the return unit, to trigger the deposit credit, when the first identifier which is recognized for the first time indicates a previously activated pledged property. The number of the recognizing processes of identifiers may therefore be reduced, when the activation of a pledged property is performed already prior or during manufacturing.

According to another embodiment, wherein the activation of a pledged property is performed at an output unit, the method may comprise, when transferring the entitlement to the pledged property to the user, recognizing the first identifier, and when transferring the pledged property to the return unit, repeatedly recognizing the first identifier. In a corresponding manner, at the arrangement, the output unit or the user terminal device may be configured, when transferring the entitlement to the pledged property to a user, to recognize the first identifier for the first time. Furthermore, the control unit may be configured, triggered by repeatedly recognizing the first identifier at the return unit and by recognizing the second identifier, to trigger a deposit credit, when the repeatedly recognized first identifier indicates a previously activated pledged property. Both activation (for example when buying) and deactivation (when returning) of a pledged property may also be triggered by a simple scan process of a user.

According to an embodiment, the return unit may be provided with the second identifier. In particular, the second identifier may be physically connected with the return unit. Then, a user actually has to be at the location of the return unit for recognizing the second identifier, so that recognizing the second identifier in connection with recognizing the first identifier at the location of the return unit may be used as an especially reliable disposal proof.

According to another embodiment, recognizing the second identifier may comprise recognizing an intrusion of a user terminal device of the user in a predetermined spatial region around the return unit. In a corresponding manner, at the arrangement, the user terminal device and/or the control unit may be configured, for recognizing the second identifier, to recognize an intrusion of the user terminal device in a predetermined spatial region around the return unit. In particular, recognizing the second identifier may be performed by geofencing. In geofencing, the second identifier may be a location information which is stored on the side of the control unit about the location of the return unit and/or a region around this location, so that entering this region by the user with his mobile device is recognized (indeed preferably by locating the mobile device) and this may be evaluated as transferring the pledged property to the return unit (thus as disposal proof). In geofencing, the second identifier may be a location information (which is stored on the side of the control unit) about the location of the return unit and/or a region around this location. Descriptively, the geofence or the mentioned location information may be seen as the second identifier. The marked region of the geofence may thus be associated with the second identifier. By entering the associated spatial region, for example with a mobile device, the second identifier may be recognized and may be assigned to the return unit. A geofence may be a region which is defined via GPS-coordinates, for example. For example, around a yellow container, a radius (of 10 m, for example) may be defined and may be stored in a database which is accessible for the control unit by coordinates. When a person with an app for managing the pledged property on a mobile device enters this region, it is automatically recognized in the app, and it may also be assumed that the user actually will give or already gave the deposit bottle in the yellow container. In other words, entering the spatial region which is defined by geofencing around the return unit by a user with a mobile device and a pledged property may be assumed as a disposal proof for the pledged property.

According to an embodiment, it may also be enabled that multiple pledged properties (for example multiple deposit bottles) may be returned. For example, when recognizing or identifying the second identifier at a return unit (for example a garbage bag) within a certain time frame (of 3 min, for example), multiple pledged properties may be returned by recognizing the respective first identifier.

According to an embodiment, recognizing the first identifier may comprise scanning the first identifier, in particular at an output unit of the pledged property. For example, scanning the first identifier at the pledged property may be performed by a camera of a mobile device of a user as user terminal device. After scanning, a software which is installed on the user terminal device may optionally evaluate the scanned image, to determine the identification information which is connected to the first identifier for identifying the pledged property. Alternatively, the user terminal device may transmit the scanned image to the control unit, where the evaluation of the scanned image may take place. Further alternatively, scanning the first identifier may be performed by a scanning unit of the output unit of the pledged property (for example by a scanner at a supermarket checkout), wherein the scanned image may be transmitted with and/or without a preprocessing to the control unit.

Recognizing the first identifier may alternatively also be performed in another way than by scanning, for example by the first identifier of the pledged property which is configured as a transponder (for example as RFID-tag) being brought in a spatial reading region of a transponder reading device. Such a transponder reading device may be configured as a part of the output unit and/or as a part of the user terminal device, for example.

According to an embodiment, activating the pledged property may be performed triggered by transferring an activation communication message to a control unit. In particular, the control unit may be configured to activate the pledged property when receiving the activation communication message which is indicative for the (in particular first-time) recognized first identifier from the output unit or from the user terminal device (for example by a marking in a database). The activation communication message may enable the control unit, to mark the pledged property which is assigned to the first identifier in a database as being properly transferred to a user. The activation communication message may in particular be transmitted via a communication network, in particular via a wireless and/or via a wired communication network. Advantageously, an already existing communication network may be used, for example a mobile communication network or the Internet.

According to an embodiment, the activation communication message may contain a pledged property identification information which is indicative for the first identifier and therefore for the pledged property. The activation communication message may thus already contain a pledged property identification information with respect to the pledged property (for example, when the output unit or the user terminal device scans the first identifier and has already derived an identification information therefrom). This enables with advantage to keep the amount of data low, which is transmitted with the activation communication message. Alternatively, the activation communication message may contain only raw data (for example a scanned and not yet evaluated image of the first identifier) from which only by the control unit, the identification information for identifying the pledged property to be activated is extracted. Then it is dispensable to provide or to use processor resources for evaluating a scanned image at the output unit or at the user terminal device, and the control unit may execute all processor-intense data processing operations as central intelligence.

According to an embodiment, the activation communication message may contain a user identification information which is indicative for the user. In particular, this may be advantageous in case of especially valuable goods. Advantageously, the activation of a pledged property may therefore be data-technically correlated with the identity of a user (for example via the mobile phone number of a user terminal device which is actuated by the user and/or by data by which a user registers when installing an app for managing the pledged property on a user terminal device). By the correlation of a certain pledged property with the identity of a user, an additional misuse-protection may be achieved. Moreover, an information may be obtained, of whose favor the deposit credit shall be triggered when later returning or disposing the pledged property.

According to an embodiment, the transfer of the entitlement to the pledged property to the user may be performed by outputting the pledged property to the user. For example, a user may buy the pledged property in a retail store, wherein, for example at the checkout of the retail store during the buying process, the activation communication message may be triggered.

According to an embodiment, repeatedly recognizing the first identifier (or recognizing the first identifier for the first time when transferring the pledged property to the return unit) may comprise repeatedly (or first-time) scanning the first identifier, in particular by a user terminal device. Furthermore, recognizing the second identifier may comprise scanning the second identifier, in particular by a user terminal device. For this purpose, the hardware resource of a camera may be used which is present at many mobile devices (or at a user terminal device) anyway. Thereby, scanning without additional hardware-technically effort is enabled. In particular, it may be sufficient to only install a software (for example an app) on the mobile device for this purpose. This software may accomplish the link with the control unit which performs a deactivation of a first identifier and therefore of an assigned pledged property, for example, when a deposit credit was triggered.

According to an embodiment, repeatedly recognizing the first identifier (or recognizing the first identifier for the first time when transferring the pledged property to the return unit) and recognizing the second identifier may be performed by the same device, in particular by a user terminal device. For example, a QR-code at a deposit bottle and a QR-code at a garbage container may be scanned with the same user terminal device during the return process or the disposal process, i.e. with a minimum effort for a user. Thereby, the motivation for a disposal may be further increased.

According to an embodiment, the deposit credit may be triggered upon transmitting a deposit credit communication message to a control unit. In particular, the control unit may be configured to trigger the deposit credit when receiving the deposit credit communication message which is indicative for the repeatedly recognized (or recognized for the first time at the return unit) first identifier from the user terminal device. For example, when the QR-code at a deposit bottle and the QR-code at a garbage container have been scanned, the scanned data (thus raw data or process data) may be transmitted in a common deposit credit communication message to the control unit, to document a return process or disposal process of the pledged property. This reduces the amount of data to be transmitted in connection with triggering the deposit credit in exchange to the return or disposal of the pledged property.

According to an embodiment, the deposit credit communication message may contain a deposit credit identification information which is indicative for the user. Thus, advantageously, triggering a deposit credit may be data-technically correlated with the identity of a user (for example via the mobile device number of a user terminal device which is actuated by the user and/or by data by which a user registers when installing an app for managing the pledged property on a user terminal device). By the correlation of a returned or disposed pledged property with the identity of a user, an additional misuse-protection may be achieved. Moreover, an information may thereby be obtained, of whose favor the deposit credit shall be triggered when returning or disposing the pledged property.

According to an embodiment, triggering the deposit credit may be performed only when repeatedly recognizing the first identifier (or recognizing the first identifier for the first time when transferring the pledged property to the return unit) and recognizing the second identifier are performed within a predetermined time interval. In particular, the control unit may be configured to trigger the deposit credit only when repeatedly recognizing the first identifier and recognizing the second identifier are both performed within the predetermined time interval. For example, the predetermined time interval may be not more than 15 minutes, in particular not more than 10 minutes, further in particular not more than 5 minutes. In this way, the error-robustness and the misuse-security of the system for managing the pledged property may be advantageously improved. Due to reasons of an environmental protection, a user shall be motivated for returning or disposing the pledged property. When the deposit credit as reward for the proper return or disposal is made dependent from a sufficiently narrow temporal connection between the first-time or the repeated recognition of the first identifier and the first-time recognition of the second identifier, it may be ensured that the deposition credit is triggered only when the pledged property is actually returned or disposed.

When the maximum time interval is exceeded, a user may give the possibility to trigger a deposit credit by repeatedly recognizing the first identifier and repeatedly recognizing the second identifier within a further predetermined time interval. Thereby, a deposit credit may also be enabled when a user was too slow in the first attempt of the double scan.

According to an embodiment, the predetermined time interval may be selected to be sufficiently long (for example at least 30 minutes or even 90 minutes), for example, to enable for a user to scan a pledged property already at home and only subsequently select a collection point. In such an embodiment, an additional misuse-protection may be implemented.

According to an embodiment, triggering the deposit credit may be optionally performed only when repeatedly recognizing the first identifier (or recognizing the first identifier for the first time when transferring the pledged property to the return unit) and recognizing the second identifier are performed within a predetermined spatial region. In particular, the control unit may be configured to trigger the deposit credit only when repeatedly recognizing the first identifier and recognizing the second identifier are performed within the predetermined spatial region, i.e. the user is actually positioned at the location of the return unit during the return or disposal. For example, the predetermined spatial region may be not more than 50 meters, in particular not more than 10 meters, further in particular not more than 1 meter. The proneness to errors and/or the misuse-protection of the system for managing the pledged property may be further improved, when the deposit credit is only triggered when repeatedly scanning the first identifier at the pledged property and scanning the second identifier at the return unit are in a sufficiently narrow spatial connection. For example, a corresponding location information may be obtained from a user terminal device (in particular a mobile device) of the user, by which the first and the second identifier may be scanned when returning the pledged property. Such location information may also be provided by a return unit.

In an alternative embodiment, scanning may be left spatially open.

An especially reliable misuse-protection may be achieved when triggering the deposit credit is performed only been fulfilling the time condition and the location condition according to both previously described embodiments.

According to an embodiment, the user terminal device and/or the output unit and/or the control unit may be coupled by a communication network, in particular by a wireless communication network, further in particular by a mobile communication network, or by the public Internet. Optionally, also the return unit may be communicatively integrated in the communication network.

Advantageously, already existing communication networks may be used, i.e. an existing infrastructure for the system for managing the pledged property, without the provision of a proprietary or separate communication network being mandatory. Similarly, providing a proprietary or separate communication network is possible according to another embodiment.

According to an embodiment, at least one of the first identifier and the second identifier may be a unique identifier. In other words, the respective identifier may be unique, i.e. may not be used a second time in an identical form in the system for managing the pledged property. In particular, no two pledged properties are provided with the same first identifier in the method or the arrangement. Thereby, an even more error-robust operation is ensured.

According to an embodiment, the first identifier may comprise an additional security information. For example, the first identifier may comprise an information about the manufacturing unit or another security information, to avoid a misuse.

### DETAILED DESCRIPTION OF EXEMPLARY EMBODIMENTS

In the following, exemplary embodiments of the present invention are described in detail with reference to the following figures.

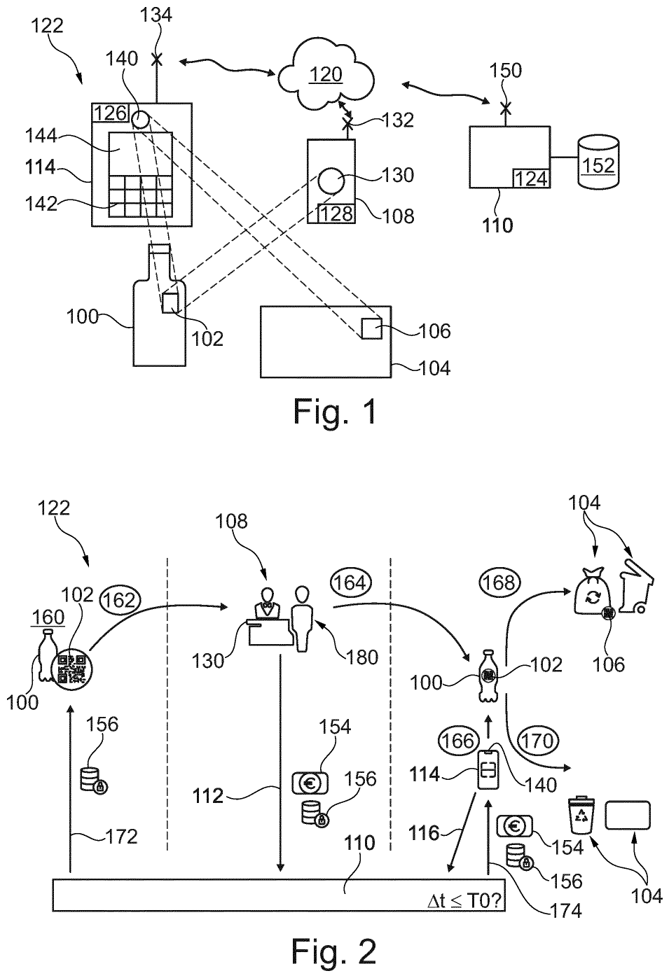

FIG. 1 shows an arrangement for managing a pledged property according to an exemplary embodiment of the invention.

FIG. 2 shows a scheme for managing the pledged property according to an exemplary embodiment of the invention.

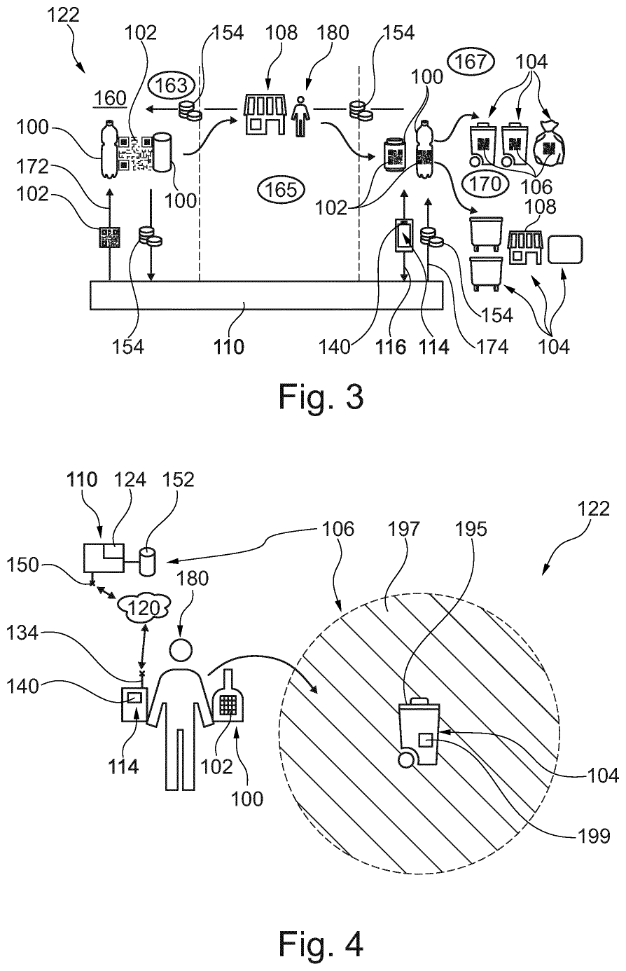

FIG. 3 shows a scheme for managing the pledged property according to a preferred other exemplary embodiment of the invention.

FIG. 4 shows a scheme for managing the pledged property according to another exemplary embodiment of the invention.

Same or similar components in different figures are provided with the same reference numbers.

Before embodiments are explained which are shown in the figures, some aspects of embodiments of the invention are explained in more detail.

According to an exemplary embodiment of the invention, a digitally supported cycle of pledged properties, for example beverage bottles (in particular PET (polyethylene terephthalate)-beverage bottles) may be realized. A corresponding arrangement encompasses a central control unit, by which a digitalized deposit system of a large number of pledged properties (in particular disposable PET-beverage bottles) may be enabled. In particular, such an arrangement and a corresponding software-based method enable a transparent and digital management of the deposit payment, the deposit repayment, and the disposal. Advantageously, such an arrangement and such a method are implementable with a very low effort. A simple deposit system which is operable in an uncomplicated manner may be provided for a user, which may be supported on the side of the user by a mobile device or the like, on which for example an app for managing the pledged property of the user may be installed. Embodiments of the invention are compatible with existing established deposit systems (for example the system which is common in Austria with a yellow bag and/or a container-collection system).

Exemplary embodiments of the invention have advantages with respect to conventional deposit management systems. On the one hand, they enable a simple and user-friendly motivation mechanism for increasing the collection rate. Moreover, a merely low infrastructure effort and the dispensability of additional transports and actions are advantageous. The co-use of existing communication networks (in particular mobile communication networks and/or the Internet) and common user terminal devices (in particular mobile devices) are further advantages of the arrangement and the method according to exemplary embodiments of the invention. In particular, exemplary embodiments of the invention may be embedded in existing collection systems and recycling systems without a significant retrofitting effort, so that no elaborate implementation of a parallel system is required.

FIG. 1 shows an arrangement 122 for managing pledged properties 100 according to an exemplary embodiment of the invention. Despite only one pledged property is illustrated, an arbitrarily large number of pledged properties may be managed.

The arrangement 122 comprises an output unit 108 for outputting the pledged property 100. For example, the output unit 108 is a retail store in which beverages are sold in a pledged property 100 which is configured as beverage bottles, for example. For example, the output unit 108 may comprise a reading device 130, such as an optical scanner, which is arranged at a checkout of the output unit 108, for example. The reading device 130 may be communicatively connected by a communication interface 132 with a communication network 120. For example, the communication network 120 may be the Internet. Furthermore, the output unit 108 may comprise a processor 128 which may be configured for preprocessing or processing scanned data, for example.

FIG. 1 shows the pledged property 100 as a further constituent of the arrangement 122, which is provided with a first identifier 102. In the illustrated example, the first identifier 102 is a unique QR-code. In other words, a unique QR-code is assigned to each pledged property 100, so that a respective pledged property 100 is uniquely identifiable by the assigned QR-code.

The arrangement 122 further encompasses a return unit 104 (for example a garbage bag) which is provided with a second identifier 106. In the illustrated example, also the second identifier 106 is a unique QR-code. In other words, a unique QR-code is assigned to each return unit 104, so that a respective return unit 104 is uniquely identifiable by the assigned QR-code.

Moreover, a user terminal device 114 may be a part of the arrangement 122. In the illustrated embodiment, the user terminal device 114 is carryable or portable and may therefore be carried by a user 180 (compare FIG. 2). The illustrated user terminal device 114 is a mobile device. The user terminal device 114 may be communicatively connected by a communication interface 134 with a communication network 120. The user terminal device 114 may comprise a camera 140 which may function as an optical scanner, for example. Furthermore, the user terminal device 114 may comprise a processor 126 which may be configured for preprocessing or processing scanned data, for example. The user terminal device 114 also has a control panel 142 and a display unit 144.

Thus, in the arrangement 122 according to FIG. 1, the user terminal device 114, the output unit 108, and a control unit 110 are communicatively coupled to each other via the communication network 120.

The control unit 110 which is here configured as a central computer, is also a part of the arrangement 122. The control unit 110 may also be communicatively connected by a communication interface 150 with a communication network 120.

Furthermore, the control unit 110 may comprise a processor 124 which may be used for controlling the communication and for data processing. Moreover, the control unit 110 comprises a storage unit 152 for storing data. The processor 124 of the control unit 110 may have a writing access and/or reading access to the storage unit 152. In the storage unit 152, a database may be stored which may contain data sets which are assigned to the single pledged properties 100.

In the following, the operation of the arrangement 122 is described:

At first, a user 180 buys a beverage bottle which contains or constitutes the pledged property 100 at the output unit 108. When buying the pledged property, the user 180 pays the deposit at the output unit 108. When transferring an entitlement to the pledged property 100 to the user 180, the reading device 130 recognizes the first identifier 102 of the pledged property 100 by optical scanning. For example, this may be performed at the checkout of the output unit 108, when the user 180 buys the pledged property 100. Alternatively, recognizing the first identifier 102 may also be performed by the camera 140 of the user terminal device 114 which is carried by the user 180. When the first identifier 102 is scanned by the reading device 130 or the camera 140, the scanned image or an identification information which is extracted therefrom by the processor 128 of the output unit 108 or the processor 126 of the user terminal device 114 for identifying the pledged property is transmitted via the communication network 120 to the control unit 110. For this purpose, the output unit 108 or the user terminal device 114 may transmit an activation communication message 112 (see FIG. 2) to the control unit 110. Activating the pledged property 100 in the database of the control unit 110 may be performed triggered by transmitting the activation communication message 112 to the control unit 110. The control unit 110 may be configured to activate the pledged property 100 when receiving the activation communication message 112 which is indicative for the recognized first identifier 102 from the output unit 108 or from the user terminal device 114. The control unit 110 is configured, triggered by recognizing the first identifier 102 and by receiving the activation communication message 112, to activate the pledged property 100. This may be performed by creating or modifying a data set which is assigned to the identified pledged property 100 in the database of the storage unit 152, by storing the information for this pledged property 100, that the pledged property 100 was bought by the user 180.

After the user 180 has emptied the beverage bottle, the user 180 may return or dispose the pledged property 100 in the manner which is described in the following. For this purpose, the user 180 goes to the return unit 104 and inserts the pledged property 100 into it. The user 180 operates his user terminal device 114 at the return unit 104, such that, when transferring the pledged property 100 to the return unit 104, he repeatedly recognizes or scans the first identifier 102 and recognizes or scans the second identifier 106 for the first time at the return unit 104. For example, the user 180 scans both QR-codes of the identifiers 102, 106 by the camera 114 of the user terminal device 114. The user terminal device 114 may then transmit via the communication network 120 a deposit credit communication message 116 to the control unit 110. The deposit credit may be triggered upon transferring a deposit credit communication message 116 to the control unit 110.

The control unit 110 is configured, when receiving the deposit credit communication message 116 and therefore triggered by repeatedly recognizing the first identifier 102 and by recognizing the second identifier 106, to trigger a deposit credit in favor of the user. Thus, the control unit 110 is configured to trigger the deposit credit when receiving the deposit credit communication message 116 which is indicative for the repeatedly recognized first identifier 102 from the user terminal device 114. This deposit credit is triggered by the control unit 110, when the repeatedly recognized first identifier 102 indicates a pledged property 100 which is previously activated in an assigned data set of the database, which pledged property did not trigger a deposit credit yet. By triggering a deposit credit only when the database indicates that the user 180 previously bought the pledged property 100 and did not receive a deposit credit for this pledged property 100 before, an error-robust and misuse-secure operation may be enabled. However, it is to be emphasized that the entitlement for returning does not have to be, but may be, person-related. For example, a first user may buy a pledged property 100 and a second user may receive the deposit, by the second user recognizing (for example scanning) both identifiers 102, 106 at a return unit 104.

With advantage, the control unit 110 may be configured to trigger the deposit credit only when repeatedly recognizing the first identifier 102 and recognizing the second identifier 106 are performed within a predetermined time interval of maximum 5 minutes, for example. Thereby, it may be ensured that the deposit credit is triggered only when a disposal proof or return proof with respect to the pledged property 100 to the return unit 104 is provided, indicated by the temporarily narrow distance between scanning both identifiers 102, 106. To further improve the misuse-security, triggering the deposit credit may further be made depending on that scanning both identifiers 102, 106 did take place at spatially narrowly neighbored positions, for example in a distance of less than 10 m. The corresponding location information and/or time information may be contained in the communication message 116. The user terminal device 114 may transmit the information, at which times or in which temporal distance scanning both identifiers 102, 106 was performed. Furthermore, the user terminal device 114 may transmit the information, at which locations or in which temporal distance scanning both identifiers 102, 106 was performed, to the control unit 110.

The mentioned communication messages 112, 116 may be transmitted in an encrypted form. Thereby, the data security and the misuse-security of the arrangement 122 may be further improved.

FIG. 2 shows a scheme for managing the pledged property 100 according to an exemplary embodiment of the invention. Thus, FIG. 2 shows a method and an arrangement 122 according to an embodiment of the invention. With respect to FIG. 2, reference is made to the description of FIG. 1. Supplementary, in the following, the pledged property management according to FIG. 2 is described as follows:

Cash flows or valuable flows which are related to the payment of a deposit for a pledged property 100 by a user 180 and to a deposit credit when returning the pledged property 100 at the return unit 104, are illustrated in FIG. 2 with the reference sign 154. With the reference sign 156, (preferably encrypted) communication messages are illustrated in FIG. 2, which are transmitted between the control unit 110, the output unit 108, the user terminal device 114, and optionally a manufacturing unit 160. The manufacturing unit 160 is related to a producer of the pledged property 100 which is here configured as a beverage bottle which is initially filled with a beverage.

As illustrated with the reference sign 162, the manufacturing unit 160 may receive first identifiers 102 for newly produced or recycled pledged properties 100, which are assigned to them and are preferably unique, from the control unit 110. These identifiers 102 may be provided by an electronic identifier communication message 172, wherein the identifier communication message 172 may contain an information for physically manufacturing the first identifiers (for example QR-codes). Alternatively, the control unit 110 may transmit physical first identifiers 102 to the manufacturing unit 160. Thus, a producer or the manufacturing unit 160 may print a unique and not yet activated QR-code on a respective PET-bottle which forms a respective pledged property 100.

As illustrated with the reference signs 162 and 164, the manufacturing unit 160 may provide the pledged property 100 which is (in particular filled with a beverage and) provided with the first identifier 102 to the output unit 108. Then, the retailer as example for an output unit 108 sells the pledged property 100 to a user 180, activates the first identifier 102 of the pledged property 100 (i.e. the unique QR-code of the bottle) by transferring the electronic activation communication message 112, and pays the deposit, compare reference sign 154. Thus, activating the pledged property 100 is performed as a consequence of transmitting the activation communication message 112 to the control unit 110. The activation communication message 112 contains a pledged property identification information which is indicative for the first identifier 102. Thus, when transferring the entitlement to the pledged property 100 to the user 180, the first identifier 102, the pledged property 100 is provided with, is recognized (in particular scanned). The transition of the entitlement to the pledged property 100 to the user 180 is performed by outputting the pledged property 100 to the user 180. Recognizing the first identifier 102 is here performed by scanning the first identifier 102 at the output unit 108 of the pledged property 100. When receiving the activation communication message 112, the control unit 110 activates the pledged property 100 which is assigned to the first identifier 102, to which the activation communication message 112 relates.

As illustrated with the reference signs 166 and 168, the user 180 later disposes the emptied pledged property 100 under providing a disposal proof by scanning the first identifier 102 of the pledged property 100 and the second identifier 106 of the return unit 104 (i.e. by scanning both QR-codes). Repeatedly recognizing the first identifier 102 is performed by repeatedly scanning the first identifier 102 by the user terminal device 114. Recognizing the second identifier 106 is performed by scanning the second identifier 106 by the user terminal device 114. When receiving the electronic deposit credit communication message 116, the user 180 receives the deposit credited to his account. Thus, the deposit credit is triggered when transmitting the deposit credit communication message 116 to the control unit 110. The credit of the pledged property may be confirmed or performed by an electronic deposit credit communication message 174. The deposit credit communication message 174 may be transmitted to the user terminal device 114 and/or to another entity (not illustrated, for example a banking institution where the user 180 has an account). Thus, when transferring the pledged property 100 to the return unit 104, a second recognition of the first identifier 102 and a first recognition of the second identifier 106, the return unit 104 is provided with, is performed. Furthermore, a deposit credit is triggered when the first identifier 102, which is recognized for the second time, indicates a previously activated pledged property 100 for which no deposit credit was triggered yet. Thereby, a double refund of the deposit for the pledged property 100 is prevented.

Advantageously, triggering the deposit credit is performed only when repeatedly recognizing the first identifier 102 and recognizing the second identifier 106 are performed within a predetermined time interval of T0=10 min, for example. The condition Δt≤T0 has to be fulfilled. Here, Δt is the time interval between scanning the identifiers 102, 106 at the return unit 104.

As illustrated with the reference sign 168, the user 180 scans, by his user terminal device 114, as second identifier 106 for example a QR-code of a garbage bag (such as a yellow bag) or of a garbage container as return unit 104, and as first identifier 102 the unique QR-code of the bottle (as disposal proof) and therefore receives the deposit.

As illustrated with the reference sign 170, the user 180 may also return the pledged property 100 at public collection points as return units 104 (for example a waste collection center, a public return point, etc.) and receives the deposit credited to his account or paid out there.

FIG. 3 shows a scheme for managing the pledged property 100 according to another preferred exemplary embodiment of the invention. Therefore, FIG. 3 shows a method and an arrangement 122 according to an embodiment of the invention which is alternative to FIG. 2. With respect to FIG. 3, reference is made to the description of FIG. 1 and FIG. 2. Supplementary, in the following, the pledged property management according to FIG. 3 is described as follows:

According to FIG. 3, in contrast to FIG. 2, activating the pledged property 100 may be performed already prior to the transition of the entitlement to the pledged property 100 to the user 180 (which happens subsequently at the location of the output device 108). In more detail, according to FIG. 3, activating the pledged property 100 may be performed by the control unit 110 prior or while providing an identification code (which may be a virtual data set which may contain an information for physically manufacturing the first identifier 102) or the first identifier 102 (for example a physical body, such as a QR-code-label which is indicative for the identification code) from the control unit 110 to a manufacturing unit 160. Then, the manufacturing unit 160 functions for manufacturing the pledged property 100 and for providing the pledged property 100 with the first identifier 102. Thus, according to FIG. 3, the control unit 110 is configured for activating the respective pledged property 100 prior or during manufacturing, namely by a first identifier 102 which is assigned to the respective pledged property 100 and/or an identification code which is assigned to the respective pledged property 100 being activated by the control unit 110. The control unit 110 functions for providing the identification code or the first identifier 102 to the manufacturing unit 160 and activates the pledged property 100 prior or during providing the identification code or the first identifier 102 to the manufacturing unit 160.

Since, when transferring the entitlement to the pledged property 100 to the user 180 at the location of the output unit 108, the pledged property 100 was already activated, according to FIG. 3, recognizing the first identifier 102 at the output unit 108 is dispensable. Therefore, neither a retrofitting of a conventional output unit 108 for participating in the described method, nor a scanning process at the location of the output unit 108 is necessary. The activation prior or during the manufacturing thus significantly simplifies the arrangement 122.

Then, when transferring the pledged property 100 to the return unit 104, recognizing the first identifier 102 for the first time is performed, for example by the user 180, using his user terminal device 114 and an app which is installed thereon for managing the pledged property 100, scanning the first identifier 102 which is configured as a QR-code, for example. The control unit 110 is correspondingly configured to trigger the deposit credit, triggered by recognizing the first identifier 102 at the return unit 104 for the first time and by recognizing the second identifier 106 at the return unit 104, when the first identifier 102 which is recognized for the first time indicates a previously activated pledged property 100. Recognizing the second identifier 106 is performed, for example by the user 180, using his user terminal device 114, scanning the second identifier 106 which is also configured as a QR-code, for example.

As illustrated with the reference sign 163, according to FIG. 3, a direct application of the first identifier 102 on a pledged property 100 may be performed, for example on bottles or cans or on a label. For example, the manufacturer (for example a bottle manufacturer or a bottler) or the manufacturing unit 160 prints a unique QR-code on a single bottle or can. This QR-code or another first identifier 102 may be activated preferably at the latest when delivering. For example, this activation may be performed prior or during manufacturing an assigned pledged property 100 by receiving the first identifier 102 in a database of the control unit 110, in which database activated pledged properties 100, by reference to their respective first identifier 102, may be marked as activated. The manufacturer or the manufacturing unit 160 may pay the deposition to the control unit 110, for example (see reference sign 154).

As illustrated with the reference sign 165, the retailer or an output unit 108 buys the bottle or the can inclusively the deposit from the manufacturer or the manufacturing unit 160. By the output unit 108, the bottle or can with the deposit may be further sold to a consumer, i.e. the user 180.

After emptying the bottle or the can, the user 180, as indicated with the reference sign 167, by a double recognition of the identifiers 102, 106, may provide a disposal proof and the deposit may be credited to his account or paid out. When the bottle or the can is returned to the retailer (for example at the output unit 108, which may then function as return unit 104), the retailer pays the deposit and/or gets it returned from the control unit 110.

Thus, according to FIG. 3, the code in form of the first identifier 102 is already attached and activated when manufacturing the product, i.e. in this embodiment the activation of a pledged property 100 is performed not only when vending.

The manufacturer or the manufacturing unit 160 receives (for example buys) the code or the first identifier 102 (preferably a unique identifier) from the central deposit system (in particular the control unit 110). This code or the first identifier 102 may be already activated and is glued, printed, lasered, or attached in another form, on the pledged property (for example a bottle or a can). The manufacturer or the manufacturing unit 160 sells the pledged property 100 with a content and the first identifier 102 to the retailer, for example to the output unit 108. The retailer or the output unit 108 sells the pledged property 100 with the content and the first identifier 102 to the consumer or user 180. This means that, in this embodiment, no separate activation of the pledged property 100 under participation of the output unit 108 and/or the user 118 is necessary.

The further course of the method according to FIG. 3 may correspond to that according to FIG. 2: for returning the pledged property 100, the user 180 scans the first identifier 102 on the pledged property 100 and returns the pledged property 100 at a return unit 104, for example in a yellow bag or in a container at home. The proof for the disposal may be performed by a scan of a second identifier 106 at the return unit 104 (for example on the back or the container). Data which are indicative for these scans may then be transmitted to the control unit 110, for which purpose an app on the user terminal device 114 may be used.

Alternatively, it is possible that the user 180 detects or recognizes (for example scans) the first identifier 102 on the pledged property 100 and disposes the pledged property 100 at a central collection point. In this case, the proof for the disposal may be performed by a geofence which surrounds a container of the central collection point. For this geofencing, an app on a user terminal device 114 (for example a mobile device) of the user 180 may be used, to compare the location information about the position of the user 180 (and thus indirectly of the pledged property 100, since the user 180 carries it) with a pre-known location information of the geofence around the return unit 104. A return by geofencing is described in more detail with reference to FIG. 4. Alternatively, it is possible that the user 180 returns the pledged property 100 to the retailer (i.e. at an output unit 108). Then, also a return without an app may be enabled for the user 180, for example under provision of a machine for the return.

The first identifier 102, when returning by scanning with the assistance of the app on the user terminal device 114, is automatically deactivated when also the second identifier 106 of the return unit 104 was recognized by geofencing or in form of a QR-code. The user 180 receives the deposit credited on his account (for example specified in the app) from the central system, for example from the control unit 110. Alternatively, the user 180 may receive the deposit back from the retailer (i.e. from the output unit 108), when the pledged property 100 is returned there. The output unit 108 receives the deposit for this pledged property 100 credited back from the central system, in particular from the control unit 110.

FIG. 4 shows a scheme for managing the pledged property 100 according to yet another exemplary embodiment of the invention.

According to FIG. 4, recognizing the second identifier 106 is performed by recognizing an intrusion of a user terminal device 114 of the user 180 in a predetermined spatial region 197 around a position 195 of the return unit 104 by geofencing. For this purpose, the user terminal device 114 and/or the control unit 110 is or are configured, for recognizing the second identifier 106, to recognize an intrusion of the user terminal device 114 in the predetermined spatial region 197 around the position 195 of the return unit 104. The position 195 of the return unit 104 and the predetermined spatial region 197 (for example a circle with a diameter of 10 m) may be stored in the database 152 to which the control unit 110 has access. The position 195 and/or the spatial region 197 may be used as the second identifier 106 for identifying the return unit 104. When the user terminal device 114 with the user 180 and the pledged property 100 intrudes in the spatial region 197, the presence of the pledged property 100 in the spatial region 197 is recognized as the second identifier 106 of the return unit 104. When a localization of the user terminal device 114 results that the user 180 enters the spatial region 197, this may be interpreted as recognizing the second identifier 106. This event may be evaluated as proof for the disposal.

FIG. 4 also shows an optional GPS-device 199 which may be attached to the return unit 104, so that the return unit 104 may transmit its actual position 195, for example to the control unit 110.

Preferably, a geofence may also be implemented at an output unit 108 (for example in a storage) as a fraud prevention. For example, when at the output unit 108, a return unit 104 (for example a yellow container) is arranged, it may be defined, how many pledged properties 100 a user 180 is allowed to return at the return unit 104 per day (for example maximum 12 bottles/day). Thereby, it may be prevented that a storage employee, by the activated first identifiers 102, scans and pretends to deposit arbitrarily much pledged properties 100 and therefore collects the deposit.

Supplementary, it is to be noted that “comprising” does not exclude other elements or steps and “a” or “an” does not exclude a plurality. Furthermore, it is noted that features or steps which are described with reference to one of the above embodiments, may also be used in combination with other features or steps of other above-described embodiments. Reference signs in the claims are not to be construed as limitation.

1-43. (canceled)

44. Method for managing a pledged property, wherein the method comprises:
prior or during a transfer of an entitlement to the pledged property to a user, activating the pledged property, wherein the pledged property is provided with a first identifier;
when transferring the pledged property to a return unit, recognizing the first identifier and recognizing a second identifier which is assigned to the return unit; and
triggering a deposit credit when the first identifier which is recognized at the return unit indicates a previously activated pledged property.

45. Method according to claim 44, wherein the method comprises at least one of the following features:
activating the pledged property prior or while providing an identification code or the first identifier to a manufacturing unit for manufacturing the pledged property and for providing the pledged property with the first identifier, wherein the first identifier is indicative for the identification code;
when transferring the entitlement to the pledged property to the user, activating the pledged property;
when transferring the pledged property to the return unit, recognizing the first identifier for the first time;
when transferring the entitlement to the pledged property to the user, recognizing the first identifier, and when transferring the pledged property to the return unit, repeatedly recognizing the first identifier;
wherein the return unit is provided with the second identifier;
wherein recognizing the second identifier comprises recognizing an intrusion of a user terminal device of the user in a predetermined spatial region around the return unit;
wherein recognizing the second identifier is performed by geofencing;
wherein recognizing the first identifier comprises scanning of the first identifier.

46. Method according to claim 44, wherein activating the pledged property is performed by being triggered by transferring an activation communication message to a control unit.

47. Method according to claim 46, comprising at least one of the following features:
wherein the activation communication message contains a pledged property identification information which is indicative for the first identifier;
wherein the activation communication message contains a user identification information which is indicative for the user.

48. Method according to claim 44, comprising at least one of the following features:
wherein the transition of the entitlement to the pledged property to the user is performed by outputting the pledged property to the user at an output unit;
wherein recognizing the first identifier when transferring the pledged property to the return unit comprises scanning the first identifier;
wherein recognizing the second identifier comprises scanning the second identifier;
wherein recognizing the first identifier when transferring the pledged property to the return unit and recognizing the second identifier are performed by the same device.

49. Method according to claim 44, wherein the deposit credit is triggered upon transferring a deposit credit communication message to a control unit.

50. Method according to claim 49, wherein the deposit credit communication message contains a deposit credit identification information which is indicative for the pledged property or for the user.

51. Method according to claim 44, wherein triggering the deposit credit is only performed when recognizing the first identifier when transferring the pledged property to the return unit and recognizing the second identifier are performed within a predetermined time interval.

52. Method according to claim 51, wherein the predetermined time interval is not more than 30 minutes.

53. Method according to claim 44, wherein triggering the deposit credit is only performed when recognizing the first identifier when transferring the pledged property to the return unit and recognizing the second identifier are performed within a predetermined spatial region.

54. Method according to claim 53, wherein the predetermined spatial region is not more than 50 meters.

55. Arrangement for managing a pledged property, wherein the arrangement comprises:
an output unit for outputting the pledged property;
the pledged property which is provided with a first identifier;
a return unit, to which a second identifier is assigned;
a user terminal device; and
a control unit;
wherein the control unit is configured, prior or during a transition of an entitlement to the pledged property from the output unit to a user, to activate the pledged property;
wherein the user terminal device is configured, when transferring the pledged property to the return unit, to recognize the first identifier, and the user terminal device or the control unit is or are configured, when transferring the pledged property to the return unit, to recognize the second identifier; and
wherein the control unit is configured, triggered by recognizing the first identifier and by recognizing the second identifier, to trigger a deposit credit when the recognized first identifier indicates a previously activated pledged property.

56. Arrangement according to claim 55, comprising a manufacturing unit for manufacturing the pledged property and for providing the pledged property with the first identifier, wherein the control unit is configured for activating the pledged property prior or during manufacturing.

57. Arrangement according to claim 56, wherein the control unit is configured for providing an identification code or the first identifier to the manufacturing unit, wherein the first identifier is indicative for the identification code.

58. Arrangement according to claim 57, wherein the control unit is configured for activating the pledged property prior or while providing the identification code or the first identifier to the manufacturing unit.

59. Arrangement according to claim 55, wherein the control unit is configured, triggered by recognizing the first identifier for the first time at the output unit, to activate the pledged property.

60. Arrangement according to claim 55, comprising at least one of the following features:
wherein the control unit is configured, triggered by recognizing the first identifier at the return unit for the first time and by recognizing the second identifier at the return unit, to trigger the deposit credit, when the first identifier which is recognized for the first time indicates a previously activated pledged property;
wherein the output unit or the user terminal device is configured, when transferring the entitlement to the pledged property to a user, to recognize the first identifier for the first time;
wherein the control unit is configured, triggered by repeatedly recognizing the first identifier at the return unit and by recognizing the second identifier, to trigger a deposit credit, when the repeatedly recognized first identifier indicates a previously activated pledged property;
wherein the return unit is provided with the second identifier;
wherein the user terminal device or the control unit is or are configured, for recognizing the second identifier, to recognize an intrusion of the user terminal device in a predetermined spatial region around the return unit.

61. Arrangement according to claim 59, wherein the control unit is configured to activate the pledged property when receiving an activation communication message, which is indicative for the first identifier which is recognized for the first time, from the output unit or from the user terminal device.

62. Arrangement according to claim 55, comprising at least one of the following features:
wherein the control unit is configured to trigger the deposit credit when receiving a deposit credit communication message, which is indicative for the first identifier which is recognized at the return unit, from the user terminal device;
wherein the control unit is configured to trigger the deposit credit only when recognizing the first identifier at the return unit and recognizing the second identifier are performed within a predetermined time interval;
wherein the control unit is configured to trigger the deposit credit only when no deposit credit has yet been triggered for the pledged property;
wherein the first identifier or the second identifier is selected from a group which is consisting of a QR code, a barcode, a transponder, and an alphanumeric code;
wherein the user terminal device or the output unit or the control unit are coupled by a communication network;
wherein at least one of the first identifier and the second identifier is a unique identifier;
wherein the pledged property is selected from a group which consists of a deposit bottle, a deposit can, a container, a battery, a textile, a piece of furniture, a deposit packaging, a motor vehicle, a cuboid packaging for liquid foodstuffs or for low-viscosity foodstuffs, a can, a packaging container, a Euro palette, and an electronic device;
wherein the user terminal device is a portable device, a laptop, or a tablet-PC.

63. Computer-readable storage medium in which a program for managing a pledged property is stored, which program, when it is executed by one or more processors fully or partially executes or controls the method according to claim 44.
